(19) United States
(12) Patent Application Publication
(10) Pub. No.: US 2006/0259389 A1
(43) Pub. Date: Nov. 16, 2006

(54) Performance based compensation sporting leagues

(76) Inventor: Edward Richter, Sycamore, IL (US)

Correspondence Address: Welsh & Katz, Ltd.;Jon P. Christensen, 22nd Floor, 120 South Riverside Plaza, Chicago, IL, 60606, US

(21) Appl. No.: 11/475,573

(22) Filed: Jun. 21, 2006

Related U.S. Application Data
(63) Continuation-in-part of application No. 09/366,496, filed on Aug. 3, 1999.

(51) Int. Cl. G06Q 40/00

(52) U.S. Cl. 705/35

(57) ABSTRACT

A method, using computer means, for investing in players of a sporting league. The method includes a sports team of the sporting league employing a plurality of players and issuing a plurality of shares of stock for each of the players. The method also includes a plurality of individuals each investing in and owning at least one of the plurality of shares of stock of at least one of the plurality of players, providing trading of shares using the computer means through a global computer network wherein the price at which a player's stock trades is a factor in calculating each player's compensation, dividing at least a portion of an income of the sporting league among the plurality of individuals based upon the number of shares owned by each of the plurality of individuals and allowing the individuals to buy and sell the shares.

### FIELD OF THE INVENTION

The present invention relates generally to sporting leagues. More particularly, the present invention relates to a sporting league in which athletes are compensated based on the price of shares of stock issued in the names of each of the athletes.

### BACKGROUND OF THE INVENTION

In the not so distant past, professional sporting leagues focused on the importance of the fans who attended the games because the fans provided the primary source of income for the teams. Fans typically developed a bond with the home town teams at a young age. Nearly all of the athletes remained with the teams on subsequent seasons. As such, the fans also developed “relationships” with many of the athletes on the home town teams.

Many professional sporting leagues now receive a significant portion of revenue from television broadcasting contracts and sky boxes. With the advent of these additional revenue sources, the salaries paid to many of the professional athletes have significantly escalated in recent years. In conjunction with the increased salary levels, athletes have become less loyal to particular teams. As a result, a significant portion of the athletes on most professional sporting teams changes from year to year.

The current compensation systems encourage young athletes who exhibit great potential in their first year or so in the professional leagues to demand high-priced, long-term guaranteed contracts. Thereafter many of the promising young athletes are injured or “lose the vision.” The teams have limited recourses in these situations because of the guaranteed nature of the contracts.

Another result of the escalating athlete salaries is significantly increased ticket, concession and souvenir prices. In spite of all these increases in revenues, more teams than ever claim to be losing money.

The movement of athletes between various sporting teams puts the fans in a dilemma—do they provide their allegiance to a particular team or do they put their allegiance in one or more individual athletes.

A drawback of the first option is that the fans must learn the names of the new athletes on each team for each season. This option is a particularly daunting where teams have poor win-loss records since it is very difficult to attract large number of fans to attend the sporting events where the fans are most likely to learn the names of the new athletes.

A drawback of the second option is that the fans must purchase a new line of clothing and souvenirs each season so that the fans can display to others their favorite athletes. This option is not only quite costly but also results in large amounts of unwanted or discarded clothing, souvenirs and sporting equipment.

Athletic teams are detrimentally affected when fans choose athletes over teams since fans are not likely to attend a sporting event unless their favorite athletes are playing. As a result, fans are more likely to watch the games on television or purchase tickets to just a few select games rather than purchasing season tickets.

One outgrowth of the tendency of fans to follow athletes rather than sporting teams is exhibited by the tremendous popularity of fantasy sports leagues. In these fantasy leagues participants assemble a team of their favorite athletes. The participants thereafter compile data relating to the performance of the individual athletes to determine the results in the fantasy league. Such fantasy leagues encourage participants to closely study the performance of a select group of athletes rather than the teams on which the athletes play.

### SUMMARY OF THE INVENTION

A method, using computer means, for investing in players of a sporting league. The method includes a sports team of the sporting league employing a plurality of players and issuing a plurality of shares of stock for each of the players. The method also includes a plurality of individuals each investing in and owning at least one of the plurality of shares of stock of at least one of the plurality of players, providing trading of shares using the computer means through a global computer network wherein the price at which a player's stock trades is a factor in calculating each player's compensation, dividing at least a portion of an income of the sporting league among the plurality of individuals based upon the number of shares owned by each of the plurality of individuals and allowing the individuals to buy and sell the shares.

### DETAILED DESCRIPTION OF THE INVENTION

While the present invention is susceptible of embodiments in various forms, there is hereinafter to be described presently preferred embodiments with the understanding that the present disclosure is to be considered an exemplification of the invention and is not intended to limit the invention to the specific embodiments described.

The present invention is a sporting remuneration system in which the athletes in the sports system (hereinafter sometimes referred to as “true star athletes”) are compensated based on the value of shares of stock issued in the names of the athletes. The athletes are thereby compensated based on the current performance rather than potential or past performance.

The sporting leagues of the present invention preferably include athletes, shares of stock issued in the names of each of the athletes, and a market for fans to purchase and sell the shares of stock. The concepts of the present invention are applicable to virtually any type of sporting league including baseball, basketball, football, hockey, and soccer.

Similar to other sporting leagues, the athletes are employed by one of the sporting teams in the league. Selection of athletes for each team is preferably accomplished using a draft format. The number of athletes on each team is determined by the type of sport. For example, football teams would have considerably more members than basketball teams.

When an athlete enters a sporting league according to the present invention, the sporting league issues shares in the name of the athlete. Each athlete preferably has an equal number of shares issued in the name of the athlete.

Alternatively, the number of shares issued varies based on the length of time the athletes are in the sporting league. With this system additional shares may or may not be issued in the name of the athlete for each year the athlete remains in the league. Such a system encourages athletes to remain in the sporting league for longer periods of time rather than switching to competing sporting leagues.

The number of shares issued for each athlete is determined based on a variety of factors such as the number of athletes in the league and the anticipated number of fans who would be purchasing the shares. Selecting an appropriate number of shares would preferably encourage the share price to generally increase at a desired rate over time.

The shares issued in the name of the athlete will hereinafter frequently be referred to as “shares of the athlete” or “player stock” even though the stock is not issued to the player, is not intended to be owned by the player in whose name the player stock is issued and does not give the owner any voting rights in any entity. The only rights accruing to the owner of player stock is the right to monetary income.

To encourage people to purchase shares of the athletes, the people who own shares of player stock at a specified time during an athletic season will each receive a portion of the league's income. Such a situation is similar to dividends paid to people who own conventional corporate securities.

The shares of player stock are traded such that the value of the shares varies based upon numerous factors including the performance of the athlete on the athletic field, the performance of the athlete's team, and the overall appeal of the athlete to the fans.

The shares of each athlete are preferably traded using an open market where bidding between perspective purchasers causes the value of shares to rise. While it is possible for the shares to be traded in an actual market where buyers and sellers assemble face-to-face that is similar to a pit in which many types of corporate securities are traded, the market is preferably computerized so that people can access a virtual market through a variety of mechanisms such as the telephone, modem or the global computer network.

To encourage widespread participation in the market each purchaser will only be able to buy a limited number of shares in each athlete on each day. Alternatively or additionally, the total number of shares that a purchaser may own for each athlete is also preferably limited. Limiting the number of shares that can be owned by a single person also reduces the possibility that share prices can be improperly manipulated.

In certain circumstances where fraud is more likely, it is desirable to prevent athletes from owning shares issued in their own names. The athletes are also subject to rules that penalize the athlete for attempting to circumvent the rules on share ownership or influence on share price. Penalties are determined based on the degree of the infraction and include forfeiture of performance bonuses, suspension, expulsion or combinations thereof.

The ability of persons to own shares may preferably be limited to people who become members of the forum or shareholders association. Such a membership preferably requires applicants to provide identifying data that prevents or substantially reduces the likelihood of fraud associated with limits on the number of shares that may be purchased or sold during specified times or limits on the total number of shares owned.

To facilitate participation on the trading forum, shareholders can preferably receive periodic updates on the value of shares, such as through a site on a global computer network, telephone network, or newspaper, such as done with many types of corporate securities.

To fund the operation of the trading market, people who trade shares pay a commission based on the number of shares purchased, the value of the shares purchased, or a combination thereof. The fees are preferably equally allocated between the seller and the purchaser. Alternatively, the fees can be entirely allocated to the seller or purchaser. In light of the computerized nature of the forum, it is envisioned that the commissions will be relatively smaller when compared to the purchase price such as less than 5 percent.

Each athlete participating in the sports league preferably receives a base salary. Depending on the structure of the sports league, the base salary may have tiers so that the base salary is increased based upon the number of years the athlete has been participating in the sporting league. Such a system encourages athletes to stay in this particular sports league rather than periodically switching between competing sports leagues.

Alternatively, the base salary is decreased based upon the number of years the athlete has been participating in the sporting league. Such a system provides athletes with wages when the players are starting in the league but encourages the athletes to take steps to enhance the price of their shares, such as improving on-field performance, granting more interviews, or working with disadvantaged children.

The athletes receive bonuses based on the value of the shares at specified periods of time during the athletic season. One preferred benchmark used to calculate bonuses is the value of shares just after the end of the athletic season. For seasons that are particularly long, such as baseball, it is preferable to use a mid-season value to award bonuses at an intermediate time during the sports season.

To encourage the athletes to work towards the success of the team for which the athlete plays, each athlete preferably receives bonuses based upon the performance of the team. For example, each of the athletes on a team would receive a first bonus for winning a division championship and a larger bonus for winning a league championship.

Since each athlete's compensation is based on the value of shares issued in the athlete's name, the athletes will be encouraged to not only perform on the athletic field but also take the extra time to interact with the fans. Such interactions are important because fans who develop a “relationship” with an athlete are more likely to want to own shares of that athlete.

Athletes who participate in sporting leagues according to the present invention will also have a greater incentive to make themselves available for interviews by the media. Additionally, athletes will be less likely to get involved in battles with the referees, coaches or management as such interactions would negatively affect the fan's desire to own shares of the athlete.

In an alternative embodiment of the present invention shares of individual players are grouped together and then sold as a group similar to mutual funds that are used with conventional corporate securities. While this group preferably includes athletes from a single athletic team, it is possible to create groups in many different ways such as athletic position or level or experience. Such a configuration encourages fans to become more knowledgeable of an entire team and thereby develop more loyalty to such a team.

Instead of teams paying for all of their own expenses including player salaries, stadium and management expenses, each of the teams (i.e., the owners) of the league contribute proportional amounts of total revenue (e.g., 60%) to a single common fund in the hands of a trustee. That common fund is called the league's “CENTRAL FUND”.

The money that was once paid out through the individual teams for player's salaries, stadium and management expenses are now distributed through this “CENTRAL FUND”. The money within the CENTRAL FUND is held for the benefit of three stakeholders, including the team owners, the players and the owners of player stock. In fact, all the revenues, both local and national, are now disbursed to the three stakeholders of the game, the players, the owners and, new to pro sports, the player stock owning fans. This system provides a fair and balanced competition among all of the teams no matter what revenues individual teams generate.

Each year the owners get 35%, the players get 35% and the player stock owning fans get 30% of all the revenues collected into each league's CENTRAL FUND during that year.

The owners get 35% of each year's CENTRAL FUND. Their piece of the pie comes from two sources. Each team gets a 40% stipend from their own efforts. They get to keep 40% of all the revenues they generated that year. This is proportional to the revenues that each team contributes to the CENTRAL FUND. The stipend should cover each team's fixed annual costs. The remaining 60% is apportioned out relative to the end-of-season team standings through the CENTRAL FUND.

The players get 35%. This is divided into base salaries, end-of-season team standings bonus and an end-of-season player stock bonus. The end-of-season player stock bonus does not come from the player stock; but, instead is determined based upon a value of the player stock.

The fans get the remaining 30% of the CENTRAL FUND. This is given back to the fans according to the player stocks that they own.

In general, the teams of the leagues play their games exactly the same way as the games of sports past.

Players are paid from the CENTRAL FUND and not from the team they play for. Players are paid from a CENTRAL FUND into which each team contributes equal proportions of unequally generated revenues. Players now compete on a level playing field.

All of the league revenues generated by the teams are accumulated and managed by each league's CENTRAL FUND. This CENTRAL FUND is then apportioned into three pieces

The new business model of market based sports (as described herein) is a CENTRAL FUND divided into three fundamental sections: owners, players, and fans. These three principles form an integral part of the charter of the present invention (i.e., rival leagues, with players who are paid for performance, through fan involvement). This is the financial model of the present invention.

Instead of each team generating their own unequal revenues and paying for their own players, the teams in the leagues contribute equal proportions of their unequally generated revenues to a CENTRAL FUND that disburse not only money to the players, but back to the owners and now to fans as well!

All National revenues for each league during any one season/year go into their respective CENTRAL FUND. As each team generates local revenues for any one season/year in the form of ticket sales, concession and merchandise sales profits, parking and local radio and television, they keep 40% and contribute 60% to the CENTRAL FUND. This is fair. Now each team contributes proportional amounts of locally generated revenues. As an incentive, the more a franchise can generate, the more it can keep of its own 40%.

All the revenues, nothing more or nothing less, generated during that season/year are distributed accordingly through the CENTRAL FUND.

Of all the local revenues including gate receipts, parking fees, merchandise and local radio and television that each team generates, the owner gets to keep 40%. This is called a stipend. The amount will vary from team to team as each team will generate different amounts of revenue due to various factors in the market, including geographic size and population density, history and tradition, popularity, etc. Keeping a percentage of everything earned locally guarantees fiscal equality among all the teams. Not only does it provide equal footing, but at the same time it provides an incentive for each team to make and keep (40% of the total) as much as they can generate, just like any other business. The rest of the teams' locally generated revenues (60%), along with all the nationally generated revenues, go to fund each league's CENTRAL FUND.

The balance of the owners' portion of the CENTRAL FUND comes back to the teams at the end of each season commensurate with how well each finished in its standings. The better a team finished, the more it receives. The worse a team performs, the less it gets back. Again, the incentive is there to put the most successful team on the field, and thereby earn the most revenue.

Obviously this plan is built around competition. Along with a fair base of compensation, 40% of locally generated revenues to offset most annual costs, the incentive is there to field the most successful teams.

If the distribution of 35% of the CENTRAL FUND among the owners doesn't sound like enough money to work on, remember that teams will no longer be responsible for any player compensation including any salaries, signing bonus', etc.

As mentioned above, the players get 35% of the CENTRAL FUND distributed to each player as a player portion. The 35% includes the base salary, the team standing bonus and the player stock bonus.

Every athlete who signs with a sports team is guaranteed an EQUAL BASE SALARY and a chance to earn additional income based on bonuses that result from end-of-season team standings.

A guaranteed base salary will be equal for each player and will be prorated according to how long the athlete stays with the team. A player may be paid for the whole season or maybe for just a half or as little as a quarter of a season based on player longevity with the team that signs him.

This is a base salary that will probably be far more than they could earn in the private sector and more than an unsuccessful pro golfer, tennis player or race car driver earns. This base salary is just the beginning for a successful, competitively compensated long lasting professional athlete. Base salaries may be equal to about 20% of the total player portion of the Central Fund.

Another 20% of the player portion is the TEAM STANDINGS BONUS. This promotes team effort. This money is disbursed to each player based on how well each team performs during the season. The better a player's team does during the season, the more a player can expect to earn. The worse a player's team does during the season, the less that player can earn.

The balance of the player's portion (the end-of-season PLAYER STOCK BONUS) is paid out to the players at the end of the season according to their market value. Market value is determined by the owners of the players stock. The owners provide the basis for deciding the PLAYER STOCK BONUS by buying and selling player stocks on an open market provided by the described sports system through the Internet.

As each athlete signs on to become a player under the described sports system, the trustee issues an amount of players stock equal to every other player. As mentioned above, players stock is issued in the name of a player without any ownership rights on the part of the named player. Instead, the trustee may distribute the players stock to interested parties on any of a number of different basis. For example, if the player is a known player of great value, then the trustee may distribute the players stock by sale at some nominal price (e.g., $1.00) per share to fans or other interested parties. Alternatively, if the player is a rookie with very little or no playing history then the truste may distribute the stock to interested parties as a premium, at no cost.

As a player's stock is bought and sold by the fans, the stock prices will fluctuate based on on-field performance and off-the-field behavior. Some players' stock thus will be more valuable than others. At the end of the season, players are given a bonus according to their stock value. The more valuable a player's stock, the bigger the bonus; the less valuable a player's stock, the less the bonus.

The incentive is there to be a successful teammate as well as a successful individual player. Conversely, the better a player is individually, the more he can earn even if he's not on a successful team. A former Major League baseball player like Kirby Puckett (playing in small market Minneapolis) or current player Ichiro Suzuki (playing for a small market, lower division team) could make plenty, given their fan popularity and individual performance.

In general, players stock is issued in the name of each player as he becomes a player within an organization using the system. Each player gets an equal amount of shares. Issued in each player's name by the trustee, this stock is of no value to the public. It is not registered with the Federal Securities and Exchange Commission as public stock. Players are not corporations that issue stock. Issues of players stock are of no inherent value to anyone, but provide a means of creating a market value based on active member (only) participation.

FAN DIVIDENDS make up the balance of each league's CENTRAL FUND. It is 30% of all the revenues generated during that season that is received by the CENTRAL FUND to be handed back to the fans. Divided up according the values of the PLAYER STOCKS, fans who own the most valued player stocks get the biggest dividends.

Fans have always wanted to be actively involved in their favorite sports. Fans want to be involved for several reasons. They not only want to be actively involved in pro sports, they want to see to it that the best players get the most reward for their efforts, again both on and off the field. They want the chance to earn (or risk loss) by buying player stock and also the chance to earn fan dividends.

In the very near future, a basketball season using the sports remuneration system may be approaching its playoffs. As an example, we may assume that there are still 12 teams vying for the 8 playoff positions in the exemplary league. The determination in the players and coaches is fever pitched, as they know that a healthy bonus potentially as high as $1.6 million to each athlete awaits the champion of the league. Teams know that a playoff appearance doesn't guarantee the big bonus money. Not only is pride on the line. The competition is fierce to finish in the top 8 to take home a minimum of $270,000 in bonus money, a nice extra chunk of change for each of the athletes whose base salary is fixed at $250,000 per year.

In its first three years of existence, we may assume that the basketball team of the exemplary league has crowned a different champion each year. Ownership of the three different teams has pieced together championship teams through both their protected list players and the supplemental annual draft of unprotected players. Seven players in the league have been fortunate enough to play on multiple champions. Ownership in these championship cities have enjoyed packed stadiums on top of team success, thereby earning million of dollars in bonuses from the CENTRAL FUND.

How have the fans responded to TruStar Basketball? More than 10 million fans own stock in TruStar Basketball players. The fan who has 100 shares invested in the player with the highest market value (as set by the fans) earned $38.00 in dividends last season. By no means are fans into TruStar Sports to get rich. However, surveys indicate fan approval is at an all-time high in the game and the players. It's the empowerment that fans now enjoy which has stimulated so much participation. Just last year, an incident off the courts in which a star TruStar Basketball player was arrested for drug possession resulted in that player's stock plummet from $10.00 a share to 65 cents. The fans took money right out of that player's wallet because of his actions. He is now doing everything he can—public service announcements, free card signing shows and more—to reach out to the fans and turn his image around. He's also stepped up his defense on the court, much to the delight of his coaches and teammates. Fans have responded by driving his stock value back up to $3.25.

The exemplary league is thriving . . . and everyone is winning, except for the rival professional leagues. The TV ratings for NBA basketball are at an all-time low and one team has folded since TruStar Basketball has arrived. Players who have played in both leagues have openly commented about the higher level of competitive play in TruStar Basketball, where so much more is at stake. All aspects of respect are higher including respect for the game, the coaches, management and the fans. No long-term contracts mean players have to prove themselves each and every season to ensure a spot on a team's roster the next year. Plus, we've already noted the increased earning potential for players on teams that finish high in the standings.

The exemplary league may be expanded to sports in general. In this regard, a number of assumptions may be made. First, lets assume an average of 24 teams each.

Each sports league will carry the same number of players on each team as past sports teams. The games are played the same way.

Each athlete has 5 million shares of TruStar Sports player stock issued in his name. This player has of no value to any player as it's only use is to be traded by member fans only to determine end of season player bonus.

Base salaries for players will be $250,000 for each full season of play. Less than full season play will be adjusted quarterly.

In general, professional sports is a $10 billion industry in America, including pro football, baseball, basketball and hockey. An established league in football, baseball, basketball and hockey under the sports remuneration system will generate $5 Billion in total revenues.

According to recent average sportspPast annual revenues in each league, the popularity in percentages of sports past are:
NFL 29.5% MLB 27.9% NBA 24.0% & NHL 18.6%

(These percentages reflect the revenues that are divided between owners and players only!). If these same percentages carry over to a league using the sports remuneration system, then the gross amounts of revenue for each sport will be:

ESTIMATED REVENUE

| | | | |
|---|---|---|---|
| ASSUMPTION “B” | 29.5% × $5 B = | $1.475 | B |
| True Star FOOTBALL | | | |
| ASSUMPTION “C” | 27.9% × $5 B = | $1.395 | B |
| True Star BASEBALL | | | |
| ASSUMPTION “D” | 24.0% × $5 B = | $1.200 | B |
| True Star BASKETBALL | | | |
| ASSUMPTION “E” | 18.6% × $5 B = | $.93 | B |
| True Star HOCKEY | | | |
| | | $5 | B |

The estimate of $1.200 B will now be used as a basis for calculating a distribution of income for a hypothetical basketball league under the sports remuneration system.

The breakdown is as follows.
Owners Portion 35%=$420,000,000.
Players Portion 35%=$420,000,000.
Fans Portion 30%=$360,000,000.

The owner's portion will be considered first. Each team retains 40% of all local and regional revenue, which will equal $168 M. This will include gate receipts, food and merchandise sales, parking, radio and television, etc. (Since each team keeps 40% of what they generate, the amounts will be different from team to team. The proportion is the same for all teams making it fair from market to market).

A second part of the owner's portion is derived from a TEAM STANDING BONUS. In this regard, 60% of Owners Portion allowed for TEAM STANDINGS BONUS or $252 M. The TEAM STANDING BONUS may be divided as follows:
1^{st} Place—10% of $252 M or $25.2 M,
2^{nd} Place—9% of $252 M or $22.7 M,
3^{rd} Place—8% of $252 M or $20.0 M,
4^{th} Place—7% of $252 M or $17.6 M,
5^{th} Place—6% of $252 M or $15.1 M,
6^{th} Place—5% of $252 M or $12.6 M,
7^{th} Place—4% of $252 M or $10.0 M,
8^{th} Place—3% of $252 M or $7.6 M and
9^{th}-24^{th} Place receive 3% of $252 M or $7.6 M each.

The players portion may be considered next. The players portion equals $1.2 billion×35% (Player portion of the CENTRAL FUND)=$420 M. That is, the players have $420 M in their portion of the pie to cover EQUAL BASE SALARIES, TEAM STANDINGS BONUS and PLAYER STOCK BONUS. The breakdown is:
approx. 20% for BASE SALARIES
20% for TEAM STANDINGS BONUS
and approx. 60% for PLAYER STOCK BONUS.

Base salaries may be considered next. Players may join or leave teams during a season due to roster moves, trades, injury or release and only receive adjusted base salaries. The base salaries may calculated as follows.
290 Players at a full season salary ($250,000)=$72.5 M
48 Players at a half season salary ($125,000)=$6.0 M
40 Players at a quarter season salary ($62,500)=$2.5 M
Total Salaries $81.M
The $81.M figure is approximately 20% of the player portion.

The TEAM STANDING BONUS may be considered next. In this case, 20% of the $420 M ($81 M) Players Portion of CENTRAL FUND is allowed for TEAM STANDINGS and is available to the top 8 playoff teams only (incentive for team success). The TEAM STANDING BONUS for each player/per team—figuring 15 players on a team is as follows.
1^{st} Place—30% of $81.0 M=$24.3 M/15 players=$1.62 M each
2^{nd} Place—25% of $81.0 M=$20.3 M/15 players=$1.35 M each
3^{rd} Place—15% of $81 0 M=$12.2 M/15 players=$810,000 each
4^{th} Place—10% of $81.0 M=$8.1 M/15 players=$540,000 each
5^{th} Place—5% of $81.0M=$4.05 M/15 players=$270,000 each
6^{th} Place—5% of $81.0 M=$3.45 M/15 players=$270,000 each
7^{th} Place—5% of $81.0 M=$3.45 M/15 players=$270,000 each
8^{th} Place—5% of $81.0 M=$3.45 M/15 players=$270,000 each

It may be noted that as shown above, sports past players earn less per playoff game than they would if they were playing a regular season game. Where's the incentive? Sports players under the sports remuneration system earn a substantial part of their total compensation through the playoffs!

The PLAYER STOCK BONUS may be considered next. The players portion of season revenue is 35% of the CENTRAL FUND amount of $420.0 M minus base salaries of $81.0 M and minus TEAM STANDING BONUS of $81.0 M to provide a difference of $258.0 M that is available for the PLAYER STOCK BONUS.

Table 1 shows a hypothetical example. As show, the total value of the players stock in Table 1 is $2,268. As such, the player nominal stock value is $258.0 M/$2,368 or $113,756.

The nominal stock value may be explained using an analogy. A group of 11 and 12 year olds get together and just for the fun of it wanted to know how much money they had collectively. Each only had pennies. Each youngster has a various amount of all the pennies. The total amount of pennies among them was 120. One of the kids, Tom had 8 pennies. If Tom owned 8 of the pennies, he had eight/one hundred twentieths or 8/120.

In sports remuneration system, each player has stock that's being bought and sold by active member fans. From player to player, each player has a various valued stock. The total value of all the players stock is the total stock value. If a player wants to know what his share of Player Stock Bonus money is, he divides his total stock value by the total value of all the players stock (total stock value) to determine his proportion of the total available ($258.0 M). If we divide the total available ($258.0 M) by the total Player Stock Bonus money, we get the PLAYER STOCK BONUS for each one-dollar value of the player stock. This is called the player nominal stock value.

A player's stock value multiplied by the nominal stock value equals his Player Stock Bonus. As another example, we may go through the following Mock-up “A” and Mock-up “B” again. If you add all of the players stock value together you come up with the Total Stock Value. Divide this Total Stock Value into the Player Stock Bonus money and you'll get the player nominal stock value. Then, $113,756.61×a players STOCK VALUE=that player's PLAYER STOCK BONUS. In Table 1, Player #1 has a stock value of $12.00. If the player stock value of $12.00 is multiplied by $113,756.61, then Player #1's PLAYER STOCK BONUS equals $1,365,079.32, as shown in the fourth column of Table 1.

The FAN DIVIDEND will be considered next. In this case $1.2 billion×30% (Fans portion of the Central Fund)=$360 M. That is, the fans have $360 M in their portion of the pie to be distributed back to active trading fans as dividends for the stocks they own.

The determination of the FAN DIVIDEND may be considered next. In this case the Basketball Total Revenue ($1.2 B), the Fans Portion (30% of CENTRAL FUND or $360.0 M). The Fans Portion ($360.0 M) divided by the total of the Players Stock value ($2268.00) equals $158,730.16 (fan nominal stock value)

This is the fan nominal stock value for each “dollar” of players stock value. We use the players total stock value because dividends to fans are based on the market value of the players—not the proportion of stocks a fan owns relative to total shares owned. If we take the value of $158,730.16 and divide the value by 5.0 M available shares of stock per player, then we find that the dividend equals $0.03175 per share of stock (nominal dividend value). To determine the FAN DIVIDEND, we multiply the nominal dividend value by the players stock value. In the case of Table 1, Player #1 has a Players Stock value of $12.00. Multiplying the Players Stock value for Player #1 ($12.00) by the nominal dividend value ($0.03175) equals a fan dividend per share of $0.380, as shown in Table 1 under Fan Dividends.

The following tables show the payouts for players and fans based on two different stock value scenarios, one that has a high end of $12.00/share (Table 1, Mock-up A), and another at $25.00/share (Table 2, Mock-up B). Table 3 summarizes Table 2.

TABLE 1
MOCK-UP SAMPLE “A”
STOCK VALUE RANGE $0-12.00

| | | | | | PLAYERS | FULL (F), | PLAYERS | |
|---|---|---|---|---|---|---|---|---|
| | PLAYERS | NOMINAL | PLAYERS | | TEAM | QUARTER (Q) or | SEASON | |
| | STOCK | STOCK | STOCK | TEAM | PLACEMENT | HALF (H) | EARNINGS WITH | FAN |
| | VALUE | VALUE | BONUS | RANK | BONUS | SEASON | BASE SALARY | DIVIDENDS |
| PLAYER #1 | $12.00 | xV | 1,365,079.32 | 2 | 1,350,000 | (F) 250,000 | 2,965,079.32 | .380 |
| PLAYER #2 | 11.95 | xV | 1,359,391.49 | 1 | 1,620,000 | (F) 250,000 | 3,229,391.49 | .379 |
| PLAYER #3 | 11.90 | xV | 1,353,703.66 | 1 | 1,620,000 | (F) 250,000 | 3,223,703.66 | .378 |
| PLAYER #5 | 11.90 | xV | 1,353,703.66 | 2 | 1,350,000 | (H) 125,000 | 2,828,703.66 | .378 |
| PLAYER #6 | 11.70 | xV | 1,330,952.34 | 3 | 810,000 | (F) 250,000 | 2,390,952.34 | .371 |
| PLAYER #7 | 11.65 | xV | 1,325,264.51 | 8 | 270,000 | (F) 250,000 | 1,845,264.51 | .370 |
| PLAYER #8 | 11.65 | xV | 1,325,264.51 | 7 | 270,000 | (F) 250,000 | 1,845,264.51 | .370 |
| PLAYER #9 | 11.55 | xV | 1,313,888.85 | 1 | 1,620,000 | (F) 250,000 | 3,183,888.85 | .367 |
| PLAYER #10 | 11.50 | xV | 1,308,201.02 | 1 | 1,620,000 | (F) 250,000 | 3,178,201.02 | .365 |
| MEAN $6.00 | | | | | | | | |
| PLAYER #371 | .20 | xV | 22,751.32 | 24 | 0 | (F) 250,000 | 272,751.32 | .006 |
| PLAYER #372 | .20 | xV | 22,751.32 | 25 | 0 | (Q) 62,500 | 85,251.32 | .006 |
| PLAYER #373 | .15 | xV | 17,063.49 | 7 | 270,000 | (F) 250,000 | 537,063.49 | .004 |
| PLAYER #374 | .15 | xV | 17,063.49 | 27 | 0 | (Q) 62,500 | 79,563.49 | .004 |
| PLAYER #375 | .05 | xV | 5,678.83 | 26 | 0 | (H) 125,000 | 130,678.83 | .001 |
| PLAYER #376 | .05 | xV | 5,678.83 | 25 | 0 | (F) 250,000 | 255,678.83 | .001 |
| PLAYER #377 | .05 | xV | 5,678.83 | 19 | 0 | (Q) 62,500 | 68,178.83 | .001 |
| PLAYER #378 | 0 | xV | 0 | 16 | 0 | (Q) 62,500 | 62,500 | 0 |
| PLAYER #379 | 0 | xV | 0 | 4 | 540,000 | (F) 250,000 | 790,000.00 | 0 |
| PLAYER #380 | 0 | xV | 0 | 28 | 0 | (H) 125,000 | 125,000.00 | 0 |
| TOTAL | | | | | | | | |
| PLAYERS | | | | | | | | |
| STOCK VALUE | $2268.00 | | | | | | | |

As may be noted, the top player earned $2.95 M for himself as well as $0.38 cents for fans owning every share of his stock. The least amount was made by the marginal player who only earned $62,500 for putting in a quarter of a season.

TABLE 2
MOCK-UP SAMPLE “B”
STOCK VALUE RANGE $0-25.00

| | | | | | PLAYERS | FULL (F), | PLAYERS | |
|---|---|---|---|---|---|---|---|---|
| | | NOMINAL | PLAYERS | | TEAM | QUARTER (Q) or | SEASON | |
| | | STOCK | STOCK | TEAM | PLACEMENT | HALF (H) | EARNINGS WITH | FAN |
| | | VALUE | BONUS | RANK | BONUS | SEASON | BASE SALARY | DIVIDENDS |
| PLAYER #1 | $25.00 | xV | 1,357,894.75 | 2 | 1,350,000 | (F) 250,000 | 2,957,894.75 | .375 |
| PLAYER #2 | 24.95 | xV | 1,355,178.96 | 1 | 1,620,000 | (F) 250,000 | 3,225,178.96 | .374 |
| PLAYER #3 | 24.90 | xV | 1,352,463.17 | 1 | 1,620,000 | (F) 250,000 | 3,222,463.17 | .373 |
| PLAYER #5 | 24.85 | xV | 1,349,747.38 | 2 | 1,350,000 | (H) 125,000 | 2,824,747.38 | .373 |
| PLAYER #6 | 24.65 | xV | 1,338,884.22 | 3 | 810,000 | (F) 250,000 | 2,398,884.22 | .370 |
| PLAYER #7 | 24.50 | xV | 1,330,736.86 | 8 | 270,000 | (F) 250,000 | 1,850,736.86 | .368 |
| PLAYER #8 | 24.25 | xV | 1,317,157.91 | 7 | 270,000 | (F) 250,000 | 1,837,157.91 | .364 |
| PLAYER #9 | 23.95 | xV | 1,300,863.17 | 1 | 1,620,000 | (F) 250,000 | 3,170,863.17 | .359 |
| PLAYER #10 | 23.85 | xV | 1,295,431.59 | 1 | 1,620,000 | (F) 250,000 | 3,165,431.59 | .358 |
| MEAN $12.50 | | | | | | | | |
| PLAYER #371 | .20 | xV | 10,863.16 | 24 | 0 | (F) 250,000 | 260,863.16 | .003 |
| PLAYER #372 | .20 | xV | 10,863.16 | 25 | 0 | (Q) 62,500 | 73,363.16 | .003 |
| PLAYER #373 | .15 | xV | 8,147.37 | 7 | 270,000 | (F) 250,000 | 528,147.37 | .002 |
| PLAYER #374 | .15 | xV | 8,147.37 | 27 | 0 | (Q) 62,500 | 70,647.37 | .002 |
| PLAYER #375 | .05 | xV | 2,715.79 | 26 | 0 | (H) 125,000 | 127,715.79 | 0 |
| PLAYER #376 | .05 | xV | 2,715.79 | 25 | 0 | (F) 250,000 | 252,715.79 | 0 |
| PLAYER #377 | .05 | xV | 2,715.79 | 19 | 0 | (Q) 62,500 | 65,215.79 | 0 |
| PLAYER #378 | 0 | xV | 0 | 16 | 0 | (Q) 62,500 | 62,500 | 0 |
| PLAYER #379 | 0 | xV | 0 | 4 | 540,000 | (F) 250,000 | 790,000.00 | 0 |
| PLAYER #380 | 0 | xV | 0 | 28 | 0 | (H) 125,000 | 125,000.00 | 0 |
| TOTAL | | | | | | | | |
| PLAYERS | | | | | | | | |
| STOCK VALUE | $4750.00 | | | | | | | |

With this stock value range the top player earned $2.957 M for himself and $0.375 cents for fans owning every share of his stock. Again, the least was made by the marginal player who only earned $62,500 for putting in a quarter of a season in a part-time, or limited, playing role.

[image]

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A method, using computer means, for investing in players of a sporting league, comprising:
a sports team of the sporting league employing a plurality of players;
issuing a plurality of shares of stock for each of the players;
a plurality of individuals each investing in and owning at least one of the plurality of shares of stock of at least one of the plurality of players;
providing trading of shares using the computer means through a global computer network wherein the price at which a player's stock trades is a factor in calculating each player's compensation;
dividing at least a portion of an income of the sporting league among the plurality of individuals based upon the number of shares owned by each of the plurality of individuals; and
allowing the individuals to buy and sell the shares.

2. The method for investing of claim 1, wherein the plurality of players receive compensation based on the price of the shares of stock at selected periods of time.

3. The method for investing of claim 1, wherein an equal amount of shares of stock is issued for each of the players.

4. The method of investing of claim 1, wherein each of the players further receives a base compensation amount.

5. A method, using computer means, for investing in players in a sporting league, comprising:
a sports team of the sporting league employing a plurality of players;
issuing a plurality of shares of stock for each of the players;
a plurality of individuals each investing in and owning at least one of the plurality of shares of stock of at least one of the plurality of players;
providing a base compensation amount to each of the players and an additional compensation amount calculated, using the computer means, based on the players stock price;
dividing at least a portion of an income of the sporting league among the plurality of individuals based upon the number of shares owned by each of the plurality of players; and
allowing the individuals to buy and sell the shares.

6. The method for investing of claims 5, wherein an equal amount of shares of stock is issued for each of the players.

7. The method of investing of claim 5, wherein the shares are traded over an electronic network.

8. A method, using a computer means, for investing in players in a sporting league having a plurality of teams, comprising:
a sports team of the sporting league employing a plurality of players;
a plurality of shares of stock issued for each of the players;
using the computer means to trade the plurality of shares of stock;
allowing a plurality of individuals to each invest in and own at least one of the plurality of shares of stock of at least one of the players of the plurality of players;
dividing at least a portion of an income of the sporting league among the plurality of individuals; and
allowing the individuals to buy and sell the shares.

9. The method of investing of claim 5, wherein a commission is received by an entity providing the website to facilitate the stock trading.

10. The method for investing as in claim 1 further comprising issuing an equal number of shares for each of the plurality of players.
